(19) United States
(12) Patent Application Publication
(10) Pub. No.: US 2024/0262727 A1
(43) Pub. Date: Aug. 8, 2024

(54) METHOD FOR IMPROVING BIOLOGICAL NITROGEN REMOVAL EFFECT OF LOW-TEMPERATURE SEWAGE

(71) Applicant: Sichuan University, Chengdu City (CN)

(72) Inventors: Ying CHEN, Chengdu City (CN); Min LIU, Chengdu City (CN)

(73) Assignee: Sichuan University, Chengdu City (CN)

(21) Appl. No.: 18/432,193

(22) Filed: Feb. 5, 2024

(30) Foreign Application Priority Data
Feb. 6, 2023 (CN) 2023100691193
Sep. 28, 2023 (CN) 2023112675134
Dec. 29, 2023 (CN) 2023118725461

(51) Int. Cl. C02F 3/12; C02F 3/34; C02F 101/16

(52) U.S. Cl. CPC C02F 3/1263; C02F 3/341; C02F 2101/16; C02F 2305/06

(57) ABSTRACT

The present disclosure provides a method for improving a biological nitrogen removal effect of low-temperature sewage, and relates to the technical field of sewage treatment. In the present disclosure, the method is implemented by adding an exogenous signal molecule. The exogenous signal molecule can intervene in a quorum sensing (QS) phenomenon among microorganisms, and can also reduce mixed liquor suspended solids (MLSS), reduce an amount of remaining sludge, and reduce a cost of sludge treatment while effectively improving the low-temperature nitrogen removal effect.

### CROSS REFERENCE TO RELATED APPLICATIONS

This patent application claims the benefit and priority to Chinese Patent Application Nos. 2023112675134 (filed Sep. 28, 2023), 2023100691193 (filed Feb. 6, 2023), and 2023118725461 (filed Dec. 29, 2023), which are each hereby incorporated by reference in their complete entireties.

### TECHNICAL FIELD

The present disclosure relates to the technical field of sewage treatment, and in particular to a method for improving a biological nitrogen removal effect of low-temperature sewage.

### BACKGROUND

Sewage treatment mainly relies on physical methods, chemical methods, and biological methods. The biological methods are widely used in domestic sewage treatment processes due to low operating costs, high removal efficiency, and convenient operation. However, microorganisms are extremely sensitive to temperature changes, with a general survival and reproduction temperature of 10° C. When the temperature is below 4° C., the microorganisms basically lose their activity, resulting in a low nitrogen removal efficiency of the biological methods under low-temperature conditions and severely limited applications.

In order to eliminate an impact of low temperature on the efficiency of biological nitrogen removal treatment, measures are generally adopted including heat insulation or heating, modification of treatment equipment, and addition of low-temperature microbial inoculant. However, construction and operation costs of measures such as the heat insulation or heating and the modification of treatment equipment are relatively high and need to be planned before construction. As a result, these measures are subject to certain limitations in existing sewage treatment plants. In addition, low-temperature resistant functional bacteria have complex and difficult screening processes and long acclimation times. Moreover, the microbial inoculant that needs to be inoculated may compete with the local bacteria in the reactor, causing the loss of bacterial strains to affect the nitrogen removal effect. The above measures also take a long time from preparation to taking effect, and cannot cope with sudden cooling and other situations.

Therefore, exogenous addition of acyl homoserine lactones (AHLs)-like signal molecules and inoculation of special quorum sensing (QS) bacteria are used for rapid start-up of biological treatment reactors at low temperatures. However, most of the existing disclosures focus on the rapid start-up of a reactor and do not further explore long-term stable operation of the reactor. At the same time, most processes in the prior art are mainly based on the addition of mixed AHLs-like signal molecules. Some long-chain mixed AHLs-like signal molecules exhibit poor solubility and are difficult to dissolve in water, thus requiring dissolution with other organic solvents. In addition, some signal molecules should be preserved at a low temperature of −20° C., thus causing high costs during storage and transportation. Moreover, some common AHLs signal molecules have high costs, and their mixed addition also increases complexity and cost of the processes.

In view of this, there is an urgent need to find an economical exogenous signal molecule to accelerate start-up of the reactor at low temperatures and further promote stable operation of the biological sewage treatment. By means of the economical exogenous signal molecule, the problem of poor nitrogen removal and water effluent during winter in cold areas is resolved.

### SUMMARY

In order to solve the above problems, the present disclosure provides a method for improving a biological nitrogen removal effect of low-temperature sewage, including: adding an exogenous signal molecule. The signal molecule can intervene in a QS phenomenon among microorganisms in a low-temperature system to be treated, effectively improve a nitrogen removal performance of the activated sludge process at low temperatures, and reduce mixed liquor suspended solids (MLSS), thereby meeting the needs of low-temperature and emergency treatment.

In the present disclosure, the exogenous signal molecule is an acyl homoserine lactones (AHLs) signal molecule.

Further, the AHLs signal molecule is one or more selected from the group consisting of N-butanoyl-L-homoserine lactone (C4-HSL), N-hexanoyl-L-homoserine lactone (C6-HSL), N-octanoyl-L-homoserine lactone (C8-HSL), and N-dodecanoyl-L-homoserine lactone (C12-HSL). Preferably, the AHLs signal molecule is the C4-HSL.

In the present disclosure, the AHLs signal molecule is preferably the C4-HSL, since the C4-HSL is less expensive than other signal molecules. Specifically, costs of the C6-HSL, C8-HSL, and C12-HSL are 20 times, 34 times, and 18 times that of the C4-HSL, respectively. In addition, the storage and transportation conditions of these signal molecules are also quite different. The C4-HSL can be stored and transported at a room temperature, while the C6-HSL, C8-HSL, and C12-HSL need to be stored and transported at −20° C. However, in general, the AHLs signal molecules used in the present disclosure still have advantages in price, storage, and transportation compared to other common AHLs signal molecules.

In the present disclosure, the exogenous signal molecule is used for a biological wastewater treatment.

Further, the biological wastewater treatment is one or more selected from the group consisting of an activated sludge process, a biofilm process, and an activated sludge-biofilm composite system process.

Further, a system to be treated in the biological wastewater treatment has a temperature of less than or equal to 12° C. Preferably, the system to be treated in the biological wastewater treatment has a temperature of less than or equal to 10° C. More preferably, the system to be treated in the biological wastewater treatment has a temperature of 4° C. to 10° C. Even more preferably, the system to be treated in the biological wastewater treatment has a temperature of 5° ° C. to 7° C.

In the present disclosure, the activated sludge process is selected from the group consisting of a sequencing batch reactor (SBR) activated sludge process and a continuous-flow activated sludge process. The AHLs signal molecule is added to the system to be treated at periodic intervals. A duration of one operation cycle is 6 h to 24 h, and a drainage ratio of each operation cycle is 30% to 50%.

Further, in the activated sludge process, the AHLs signal molecule is added to the system to be treated once every operation cycle or every 1 to 2 operation cycles.

Further, anoxic stirring and aeration are required in each operation cycle; the anoxic stirring is conducted for 2.5 h to 3 h, and the aeration is conducted for 8 h to 24 h.

Further, the activated sludge has an initial MLSS of 3,000 mg/L to 7,000 mg/L.

Further, the system to be treated has a pH value of 7 to 8.

Further, the AHLs signal molecule in the activated sludge process is added at 10 μg/L to 100 μg/L. Preferably, the AHLs signal molecule is added at 10 μg/L to 50 μg/L. More preferably, the AHLs signal molecule is added at 10 μg/L to 38 μg/L.

Further, the AHLs signal molecule in the activated sludge-biofilm composite system process is added at 40 μg/L to 100 μg/L.

In the present disclosure, the activated sludge-biofilm composite system process of the sewage treatment includes the following steps:
S1, inoculating an activated sludge of a secondary sedimentation tank using a composite activated sludge-biofilm moving bed biofilm reactor (MBBR);
S2, introducing an AHLs signal molecule following initial influent into the MBBR, where there was a sufficient alkalinity (ALK) in the MBBR, collecting an effluent from the composite activated sludge-biofilm MBBR, and detecting a pollutant removal efficiency after sewage treatment indexes are detected in the influent; and
S3, adjusting a composition of the initial influent after the MBBR has a stable treatment effect, and detecting the pollutant removal efficiency.

Further, the activated sludge has an initial MLSS of 3,000 mg/L+200 mg/L, a columnar polyethylene filler is adopted, a hydraulic retention time is 14 h to 20 h, and a dissolved oxygen concentration is greater than 1.5 mg/L in step S1.

Further, the initial influent in step S2 has a composition including chemical oxygen demand (COD) 150 mg/L+50 mg/L, ammonia-nitrogen concentration 25 mg/L+2 mg/L, and total phosphorus (TP) 2 mg/L+1 mg/L.

Further, the initial influent in step S2 further includes a trace element stock solution, and the trace element stock solution is added at 2 mL/L.

Further, the trace element stock solution includes: (0.3-0.4) mg/L EDTA, (0.3-0.4) mg/L mgSO₄·7H₂O, (3.0-4.0) mg/LCaCl₂, (0.5-0.6) mg/L FeSO₄·7H₂O, (1.0-1.5) mg/L MnCl₂·4H₂O, (0.5-0.6) mg/L ZnSO₄·7H₂O, (0.01-0.02) mg/L CoCl₂·H₂O, (0.4-0.6) mg/LH₃BO₃, (0.3-0.4) mg/L CuSO₄·5H₂O, and (0.4-0.5 mg/L Na₂MoO₄·2H₂O.

Further, the ALK is ALK/N=6.0-9.0 calculated as CaCO₃.

Further, the adjusted initial influent in step S3 includes: COD 250 mg/L±50 mg/L, ammonia-nitrogen concentration 40 mg/L±2 mg/L, and TP 4 mg/L±2 mg/L.

Further, the adjusted initial influent in step S3 includes: COD 500 mg/L±50 mg/L, ammonia-nitrogen concentration 60 mg/L±5 mg/L, and TP 6 mg/L±1 mg/L.

Further, the adjusted initial influent in step S3 includes: COD 500 mg/L±100 mg/L, ammonia-nitrogen concentration 75 mg/L±5 mg/L, and TP 8 mg/L±1 mg/L.

Further, the MBBR adopts a columnar polyethylene filler with a filling rate of 30% to 50%.

In the present disclosure, the method is suitable for sewage treatment.

Further, the sewage is one or more selected from the group consisting of domestic sewage, sewage with a water quality similar to the domestic sewage, agricultural sewage, and industrial wastewater.

Compared with the prior art, the present disclosure has beneficial technical effects:

In the present disclosure, the AHLs signal molecule is added to intervene in the QS phenomenon among microorganisms, optimize the community structure of microorganisms in the system, and stimulate the QS phenomenon. A microbial activity is enhanced, causing the microorganisms to secrete more EPS, promoting the colonization and growth of microorganisms on the filler, and providing a desirable habitat for the growth and attachment of nitrifying bacteria. The interspecies cooperation of functional bacteria is improved to achieve efficient removal of pollutants, thus effectively increasing the abundance of nitrifying bacteria, and improving the nitrogen removal performance of the activated sludge system.

In the present disclosure, the AHLs signal molecules show an obvious nitrification-promoting effect depending on the activated sludge. The addition of AHLs signal molecule promotes the growth of functional microorganisms in the activated sludge/biofilm two-phase system, and the two phases can complement each other. Especially when a concentration of influent increases, it may be difficult for a single activated sludge or biofilm to meet discharge standards, but an activated sludge-biofilm blend system can easily meet the discharge standards.

The exogenous signal molecule can reduce the MLSS, reduce an amount of remaining sludge, and reduce a cost of sludge treatment while effectively improving the low-temperature nitrogen removal effect.

Compared with common AHLs signal molecules, the AHLs signal molecule in the present disclosure is more convenient to store and easier to dissolve and operate. Moreover, adding a single AHLs signal molecule can achieve desirable sewage treatment effects, thereby avoiding the addition of mixed AHLs signal molecules, such that the raw material cost is lower to achieve a higher practical application value.

### DETAILED DESCRIPTION OF THE EMBODIMENTS

The technical solutions provided by the present disclosure will be further described below with reference to the accompanying examples.

### Example 1

A system to be treated was cooled to 10° C., and an activated sludge SBR reactor was adopted with an effective volume of 1 L and an MLSS of 4,000 mg/L.

Incoming influent: COD: 250 mg/L, ammonia-nitrogen concentration (NH₄⁺—N): 30 mg/L, TP: 1.5 mg/L, pH=7-8.

12 h was an operation cycle, including 2.5 h of anoxic phase, 8 h of aerobic phase, and 1.5 h of standing. The anoxic phase had dissolved oxygen (DO) maintained below 0.5 mg/L, and the aerobic phase had DO>2.5 mg/L.

An N-butanoyl-homoserine lactone stock solution with a concentration of 10 mg/L, which was added every 2 operation cycles following the influent. After addition, N-butanoyl-homoserine lactone had a concentration of 10 μg/L.

### Example 2

This example differed from Example 1 in that the influent was added every 2 operation cycles, and the C4-HSL after addition had a concentration of 100 μg/L.

### Example 3

This example differed from Example 1 in that the treatment system was cooled to 7° C., and after the operation was stable, the water temperature was further lowered to 4° C. The C4-HSL after addition had a concentration of 10 μg/L.

### Example 4

This example differed from Example 1 in that the treatment system was cooled to 7° C., and after the operation was stable, the water temperature was further lowered to 4° C.; the influent was added every 2 operation cycles, and the C4-HSL after addition had a concentration of 100 μg/L.

### Comparative Example 1

This example differed from Example 1 in that the system to be treated was cooled to 10° C. without adding N-butanoyl-homoserine lactone.

### Comparative Example 2

This example differed from Example 3 in that the system to be treatment system was cooled to 7° C., and after the operation was stable, the water temperature was further lowered to 4° C. without adding N-butanoyl-homoserine lactone.

### Comparative Example 3

This example differed from Example 1 in that the nitrogen removal treatment was conducted at normal temperature without adding C4-HSL.

### Comparative Example 4

This example differed from Example 1 in that the nitrogen removal treatment was conducted at room temperature, and the C4-HSL had a concentration of 10 μg/L.

### Comparative Example 5

This example differed from Example 1 in that the nitrogen removal treatment was conducted at room temperature, and the C4-HSL had a concentration of 100 μg/L.

Test Example 1 The technical effect of Example 1 was tested and the results were as follows:

A COD removal efficiency was 90%; an average NH₄⁺—N removal efficiency was 99.69%; a TN removal efficiency reached stability after 27 cycles, with an average removal efficiency of 64.97%, and an average effluent concentration of 11.40 mg/L.

After the treatment effect was stable, high-throughput sequencing was conducted on the activated sludge to analyze a composition of the microbial community. The ammonia-oxidizing bacterium MND1 had an abundance of 0.007%, and the complete nitrifying bacterium Nitrospira had an abundance of 0.100%; denitrifying bacteria Denitratisoma and Dechloromonas had abundances of 0.189% and 0.246%, respectively. The metagenomic results showed that the complete nitrification process of the activated sludge system accounted for 12.53% during the nitrogen metabolism; the abundances of CS, sdh, and fum genes involved in the tricarboxylic acid (TCA) cycle were 0.017%, 0.030%, and 0.018%, respectively; the abundances of regulatory, transport, and decomposition genes related to QS were 2.40%, 7.75%, and 1.92%, respectively. The increased abundance of functional bacteria and functional genes in the activated sludge SBR reactor improved the nitrogen removal effect of this reactor.

After the operation was stable, the MLSS of the reactor was 2% lower than that of the control group (without adding C4-HSL).

Test Example 2 The technical effect of Comparative Example 1 was tested by a test method the same as that in Example 1. The test results were as follows:

An average NH₄⁺—N removal efficiency was 72.87%; a TN removal efficiency reached stability after 27 cycles, with an average removal efficiency of 52.38%, and an average effluent concentration of 15.49 mg/L (not meeting discharge standards).

The ammonia-oxidizing bacterium MND1 had an abundance of 0.003%, and the complete nitrifying bacterium Nitrospira had an abundance of 0.089%; denitrifying bacteria Denitratisoma and Dechloromonas had abundances of 0.180% and 0.213%, respectively.

The complete nitrification process of the activated sludge system accounted for 12.46% during the nitrogen metabolism; the abundances of CS, sdh, and fum genes involved in the TCA cycle were 0.016%, 0.029%, and 0.017%, respectively; the abundances of regulatory, transport, and decomposition genes related to QS were 2.08%, 6.61%, and 1.70%, respectively. The low abundance of functional bacteria and functional genes in the activated sludge SBR reactor made the nitrogen removal effect poor, and the sewage could not meet the discharge standards under low temperature conditions.

The detection results of Example 1 and Comparative Example 1 were shown in FIG. 1 and FIG. 2. At low temperatures, the TN removal efficiency and NH₄⁺—N removal efficiency were significantly improved when adding C4-HSL compared with those when not adding C4-HSL.

Test Example 3 The technical effect of Example 2 was tested by a test method the same as that in Example 1. The test results were as follows:

A COD removal efficiency was 90%; an average NH₄⁺—N removal efficiency was 99.85%; a TN removal efficiency reached stability after 27 cycles, with an average removal efficiency of 60.46%, and an average effluent concentration of 12.86 mg/L that was less than 15 mg/L.

The ammonia-oxidizing bacteria Ellin6067 and MND1 had abundances of 0.393% and 0.005%, respectively, and Nitrospira had an abundance of 0.222%; 11 species of denitrifying bacteria (Rhodoferax, Dokdonella, Terrimonas, Sp Haerotilus, Rhodobacter, unclassified_f_Comamonadaceae, norank_f_Gemmatimonadaceae, Ferruginibacter, Tessaracoccus, Nakamurella, and norank_f_Saprospiraceae) had a total abundance of 16.53%; Heterotrophic nitrifying-aerobic denitrifying bacterium (Microbacterium) had an abundance of 0.463%.

The complete nitrification process of the activated sludge system accounted for 13.82% during the nitrogen metabolism; the nitrification gene nxr had an abundance of 0.027%, and the nitrogen removal gene nirK had an abundance of 0.015%; the abundances of CS, sdh, fum, and mdh genes involved in the TCA cycle were 0.021%, 0.040%, 0.021%, and 0.011%, respectively; the abundances of regulatory, transport, and decomposition genes related to QS were 2.98%, 9.22%, and 2.50%, respectively. The increased abundance of functional bacteria and functional genes in the activated sludge SBR reactor improved the nitrogen removal effect of the reactor.

After the operation was stable, the MLSS of the reactor was 12% lower than that of the control group (without adding C4-HSL).

Test Example 4 The technical effects of Example 3, Example 4, and Comparative Example 2 were tested by a test method the same as that in Example 1. The test results were as follows:

When the water temperature dropped to 7° C., the average NH₄⁺—N removal efficiencies of SBR added with 0 μg/L, 10 μg/L, and 100 μg/L C4-HSL after stabilization were 55.6%, 96.9%, and 96.3%, respectively; when the temperature was 4° C., the average NH₄⁺—N removal efficiencies were 45.1%, 99.3%, and 98.8%, respectively.

When the temperature was 7° C., the MLSS added with 10 μg/L and 100 μg/LC4-HSL was 22% and 19% lower than that of the control group (without C4-HSL added), respectively; when the temperature was 4° C., the MLSS added with 10 μg/L and 100 μg/LC4-HSL was 40% and 38% lower than that of the control group (without C4-HSL added), respectively.

Exogenous C4-HSL had a significant impact on the biofilm microbial community during the cooling. After the system was stabilized at a temperature of 7° C., exogenous C4-HSL increased the relative abundance of TM7a from the Patescibacteria, Nakamurella and Tessaracoccus from the Actinobacteria, and Ferruginibacter from the Bacteroidetes; when the temperature was 4° C., after the system was stable, exogenous C4-HSL promoted the increase in the relative abundance of Arthrobacter, Nakamurella, Micrococcaceae, and typical nitrifying bacterium Nitrosomonas from the Actinobacteria. It was seen that exogenous C4-HSL could increase the abundance of different dominant core bacterial genera under different temperature conditions, thereby maintaining a high level of ammonia-nitrogen treatment efficiency.

Test Example 5 The technical effects of Comparative Examples 3 to 5 were tested by a test method the same as that in Example 1. The test results were as follows:

Signal molecules C4-HSL of different concentrations (0, 10, 100 μg/L) were added externally at room temperature. After 74 cycles of operation, the removal efficiency of COD was not less than 90%; the effluent ammonia-nitrogen concentration was around 0.1 mg/L, with a removal efficiency of not less than 99%; and the effluent TN was not more than 15 mg/L. It was seen that whether C4-HSL was added at room temperature had little effect on the nitrogen removal effect.

At the phylum level, adding exogenous C4-HSL inhibited the growth of Proteobacteria and Bacteroidota, and the higher the concentration, the stronger the inhibitory effect; this measure could promote the growth and reproduction of Patescibacteria, with a promotion effect increased with the increase of concentration; Actinobacteriota and Gemmatimonadota showed inhibition at low concentrations and promotion at high concentrations. At the genus level, after adding low-concentration C4-HSL, a relative content of Nakamurella (nitrifying bacteria) dropped from 17.46% to 16.66%, and after adding high-concentration C4-HSL, the relative content increased to 20.79%. It was seen that the addition of C4-HSL promoted the growth of microorganisms at low concentrations and inhibited same at high concentrations.

### Example 5

A method for improving an efficiency of treating low-temperature sewage using a sludge-biofilm blend reactor included the following steps:

(1) An activated sludge-biofilm composite MBBR reactor with an effective volume of 1 L was used at 6° C., where an activated sludge had an MLSS of 3,000 mg/L; a filler was porous black columnar polyethylene with a filling rate of 30%; the influent included: COD: 160 mg/L, ammonia-nitrogen concentration: 25 mg/L, TP: 2 mg/L, pH=6.5-8, and a hydraulic retention time of 20 h; DO>1.5 mg/L, ALK/N=7.1; a 10 mg/L C4-HSL trace element stock solution was prepared, and C4-HSL with a concentration of 40 μg/L was added following the influent.

The trace element stock solution included: 0.38 mg/L EDTA, 0.4 mg/L mgSO₄·7H₂O, 3.6 mg/LCaCl₂, 0.56 mg/L FeSO₄·7H₂O, 1.25 mg/L MnCl₂·4H₂O, 0.55 mg/L ZnSO₄·7 H₂O, 0.016 mg/L CoCl₂H₂O, 0.6 mg/L h₃BO₃, 0.4 mg/L CuSO₄·5H₂O, and 0.5 mg/L Na₂MoO₄·2H₂O.

(2) The hydraulic retention time was 20 h, and an effluent from the reactor was collected to detect the pollutant removal efficiency. After a short period of adaptation, the COD concentration in the reactor effluent dropped below 50 mg/L, and the removal efficiency was always maintained at 85%. After adding the C4-HSL, the nitrogen removal effect gradually became more prominent. On the 16th day, the effluent ammonia-nitrogen concentration dropped below 8 mg/L (a maximum allowable emission concentration of ammonia-nitrogen from most urban sewage treatment plants at a water temperature of below 12° C.) to 6.77 mg/L, and the removal efficiency was 71.86%. On the 51st day, the ammonia-nitrogen concentration in the effluent dropped to almost 0, and the removal efficiency was greater than 99%.

(3) After the treatment effect was stable (by examining the concentration of COD and ammonia-nitrogen in the effluent, a calculated removal efficiency was relatively high and did not fluctuate greatly), the EPS and ATP of the activated sludge and biofilm phases were detected. The EPS concentration in the sludge phase was 46.12±4.8 mg/g·VSS, and the intracellular ATP was 1273.11±5.4 ngATP/mL; the EPS concentration in the biofilm phase was 53.34±3.7 mg/g. VSS, and the microbial activity concentration of a single filler was 20.67±0.22 ngATP/piece.

(4) After the treatment effect was stable (by examining the concentration of COD and ammonia-nitrogen in the effluent, a calculated removal efficiency was relatively high and did not fluctuate greatly), the influent quality was further improved. There were three stages: increasing COD from 160 mg/L to 500 mg/L (260, 400, 500 mg/L); increasing ammonia-nitrogen concentration from 25 mg/L to 75 mg/L (40, 65, 75 mg/L); increasing TP from 2 mg/L to 8.5 mg/L (4, 6, 8.5 mg/L).

In the third stage, the COD in the influent water was 500 mg/L, the ammonia-nitrogen concentration was 75 mg/L, and the TP was 8.5 mg/L. On the 234th day, after the reactor briefly adapted at each stage, the effluent COD concentration was still able to be maintained below 50 mg/L, and the removal efficiency was 95%. The nitrification effect remained well, the effluent total nitrogen (TN) concentration was stable at 12 mg/L, and the removal efficiency remained not less than 80%. The EPS concentration in the activated sludge phase was 127.07±4.5 mg/g·VSS, and the intracellular ATP was 1709.78±4.1 ngATP/mL; the EPS concentration in the biofilm phase was 113.70±2.59 mg/g. VSS, and the microbial activity concentration of a single filler was 113.99±0.67 ngATP/mL.

### Example 6

A method for improving a start-up rate and a nitrification performance of the activated sludge-biofilm blend reactor for treating low-temperature sewage included the following steps:

The influent had a pH value of 7 to 9 and a hydraulic retention time of 18 h. The C4-HSL with a concentration of 100 μg/L was added to the influent. The rest steps were the same as those in Example 5.

On the 5th day, the effluent ammonia-nitrogen concentration dropped to 5.85 mg/L, and the removal efficiency was 77.43%. On the 12th day, the removal efficiency was greater than 99%.

After the treatment effect was stable, the EPS concentration in activated sludge phase was 80.62±3.1 mg/g·VSS, and the intracellular ATP was 2441.01±7.2 ngATP/mL; the EPS concentration in biofilm phase was 96.74±2.8 mg/g·VSS, and the microbial activity concentration of a single filler was 26.56±0.42 ngATP/piece.

After the treatment effect was stable (by examining the concentration of COD and ammonia-nitrogen in the effluent, a calculated removal efficiency was relatively high and did not fluctuate greatly), the influent quality was further improved. There were three stages: increasing COD from 160 mg/L to 500 mg/L (260, 400, 500 mg/L); increasing ammonia-nitrogen concentration from 25 mg/L to 75 mg/L (40, 65, 75 mg/L); increasing TP from 2 mg/L to 8.5 mg/L (4, 6, 8.5 mg/L).

The effluent ammonia-nitrogen removal efficiency was not less than 99%; the EPS concentration in activated sludge phase was 380.38±5.7 mg/g·VSS, and the intracellular ATP was 5868.42±8.9 ngATP/mL; the EPS concentration in biofilm phase was 235.18±3.5 mg/g·VSS, and the microbial activity concentration of a single filler was 113.99±0.67 ngATP/mL.

### Comparative Example 6

The influent had a pH value of 7 to 8, no C4-HSL was added, and the rest steps were the same as those in Example 5.

The effluent ammonia-nitrogen concentration in the reactor dropped below 8 mg/L on the 66th day, and the ammonia-nitrogen removal efficiency was 94.77% on the 118th day.

The EPS concentration in activated sludge phase was 29.57±4.3 mg/g·VSS, and the intracellular ATP was 1083.52±5.1 ngATP/mL; the EPS concentration in biofilm phase was 51±1.3 mg/g·VSS, and the microbial activity concentration of a single filler was 13.01±0.71 ngATP/mL.

After the treatment effect was stable (by examining the concentration of COD and ammonia-nitrogen in the effluent, a calculated removal efficiency was relatively high and did not fluctuate greatly), the influent quality was further improved. There were three stages: increasing COD from 160 mg/L to 500 mg/L (260, 400, 500 mg/L); increasing ammonia-nitrogen from 25 mg/L to 75 mg/L (40, 65, 75 mg/L); increasing TP from 2 mg/L to 8.5 mg/L (4, 6, 8.5 mg/L).

The effluent COD removal efficiency was 95%; there was a poor nitrification effect, the effluent ammonia-nitrogen concentration was always maintained at 35 mg/L, and the removal efficiency was 50%; the EPS concentration in activated sludge phase was 129.77±3.2 mg/g·VSS, and the intracellular ATP was 1024.65±5.6 ngATP/mL; the EPS concentration in biofilm phase was 116.44±2.3 mg/g·VSS, and the microbial activity concentration of a single filler was 88.25±1.1 ngATP/mL. When C4-HSL was not added, the activated sludge-biofilm MBBR blend reactor had low microbial activity, poor nitrification effect, low EPS concentration, and poor impact load resistance. Therefore, sewage could not be discharged up to standard under low temperature conditions.

### Comparative Example 7

The influent had a pH value of 7 to 8 and a hydraulic retention time of 18 h, the sludge was discharged on the 18th day after the biofilm was successfully formed on the filler. The C4-HSL with a concentration of 100 μg/L was added to the influent. The rest steps were the same as those in Example 5.

The hydraulic retention time was 18 h, the rest steps were the same as those Example 1, and the COD removal efficiency was 85%; after the reactor was drained of sludge, the nitrification effect dropped sharply. The effluent ammonia-nitrogen concentration remained at 12 mg/L, and the removal efficiency was 40%, which did not meet the discharge standards.

Through the microbial community structure, it was found that the addition of C4-HSL under low temperature conditions was beneficial to promote the growth and enrichment of Bacteroidetes and Actinobacteria on the filler, which were both bacterial phyla related to biofilm colonization and growth. For a single biofilm system, the addition of C4-HSL could not quickly improve the nitrification effect, but could promote the colonization and growth of microorganisms on the filler to provide a good habitat for nitrifying microorganisms.

Under low temperature conditions, nitrification-related microorganisms grew slowly and had low activity, and were difficult to adhere to and colonize the filler in the early stage of film formation (without sludge discharge). The QS phenomenon triggered by the addition of C4-HSL fully acted on the microorganisms in activated sludge. Therefore, it was difficult for a single biofilm system to start up quickly and achieve water discharge standards by adding C4-HSL in the early stage.

### Comparative Example 8

A biofilm MBBR reactor with an effective volume of 1 L was used at 22° C., the influent had a pH value of 7 to 8, and aeration was conducted for 10 h to fully mix the activated sludge, filler, and sewage, and allowed to stand for 2 h. The sludge was discharged on the 12th day after the biofilm was successfully formed on the filler. The C4-HSL with a concentration of 100 μg/L was added to the influent. The rest steps were the same as those in Example 5.

Through analysis of the microbial community structure, it was found that the addition of C4-HSL promoted the growth of quorum quenching bacteria at 22° C., thus breaking the balance between QS and quorum quenching in the reactor and stimulating the quorum quenching. Therefore, the addition of C4-HSL actually inhibited the colonization and growth of biofilm. The high concentration of C4-HSL allowed the quorum quenching bacteria to grow at a suitable temperature (22±1° C.), stimulating quorum quenching and inhibiting the attachment and growth of microorganisms to the filler.

### Example 7

C6-HSL was used as the signal molecule, a concentration of the C6-HSL after addition was 10 μg/L, while the remaining steps were the same as those in Example 1. The ammonia-nitrogen removal efficiency was tested to be 82.34%.

### Example 8

A concentration of the C6-HSL after addition was 100 μg/L, while the remaining steps were the same as those in Example 7. The ammonia-nitrogen removal efficiency was tested to be 84.29%.

### Example 9

C8-HSL was used as the signal molecule, a concentration of the C8-HSL after addition was 10 μg/L, while the remaining steps were the same as those in Example 1. The ammonia-nitrogen removal efficiency was tested to be 88.37%.

### Example 10

A concentration of the C8-HSL after addition was 100 μg/L, while the remaining steps were the same as those in Example 9. The ammonia-nitrogen removal efficiency was tested to be 94.54%.

### Example 11

C12-HSL was used as the signal molecule, a concentration of the C12-HSL after addition was 10 μg/L, while the remaining steps were the same as those in Example 1. The ammonia-nitrogen removal efficiency was tested to be 90.79%.

### Example 12

A concentration of the C12-HSL after addition was 100 μg/L, while the remaining steps were the same as those in Example 11. The ammonia-nitrogen removal efficiency was tested to be 80.95%.

Particular examples are used herein for illustration of principles and implementation modes of the present disclosure. The descriptions of the above embodiments are merely used for assisting in understanding the method of the present disclosure and its core ideas. In addition, those of ordinary skill in the art can make various modifications in terms of particular implementation modes and the scope of application in accordance with the ideas of the present disclosure. In conclusion, the content of the description shall not be construed as limitations to the present disclosure.

What is claimed is:

1. A method for improving a biological nitrogen removal effect of low-temperature sewage, wherein the method is implemented by adding an exogenous signal molecule;
the exogenous signal molecule is an acyl homoserine lactones (AHLs) signal molecule; and
the AHLs signal molecule is one or more selected from the group consisting of N-butanoyl-L-homoserine lactone (C4-HSL), N-hexanoyl-L-homoserine lactone (C6-HSL), N-octanoyl-L-homoserine lactone (C8-HSL), and N-dodecanoyl-L-homoserine lactone (C12-HSL).

2. The method of claim 1, wherein the method is used for a biological wastewater treatment.

3. The method of claim 2, wherein the biological wastewater treatment is one or more selected from the group consisting of an activated sludge process, a biofilm process, and an activated sludge-biofilm composite system process.

4. The method of claim 2, wherein a system to be treated in the biological wastewater treatment has a temperature of less than or equal to 12° C.

5. The method of claim 3, wherein the activated sludge process is selected from the group consisting of a sequencing batch reactor (SBR) activated sludge process and a continuous-flow activated sludge process.

6. The method of claim 1, wherein the method is suitable for wastewater treatment.
